(19) United States
(12) Patent Application Publication
(10) Pub. No.: US 2007/0143472 A1
(43) Pub. Date: Jun. 21, 2007

(54) Method for improving the efficiency and effectiveness of instant messaging based on monitoring user activity

(75) Inventors: Robert H. Clark, Pittsburgh, PA (US); Raymond P. Dunki-Jacobs, Williston, VT (US); Robert J. Milne, Jericho, VT (US); Muthuswamy Venkatachalam, South Burlington, VT (US)

Correspondence Address: Eugene I. Shkurko, Attorney;IBM Corporation, IP Law Dept., 2455 South Road, M/S P386, Poughkeepsie, NY, 12601, US

(73) Assignee: INTERNATIONAL BUSINESS MACHINES CORPORATION, Armonk, NY (US)

(21) Appl. No.: 11/314,700

(22) Filed: Dec. 21, 2005

(51) Int. Cl. G06F 15/173; G06F 15/16

(52) U.S. Cl. 709/224; 709/206

(57) ABSTRACT

A method for improving the efficiency and effectiveness of instant messaging between users on any computing devices. One aspect of the invention is to automatically identify the status of an intended recipient and transform the details into a meaningful summary status which will be displayed to the sending user. Another aspect of the invention is to mitigate interruptions to a recipient by delaying the receipt of the message based on particular rules. Another aspect of the invention monitors the instant messaging activity of a user for efficiency and then suggests appropriate actions to improve the efficiency. The monitoring is based on measurements taken periodically and a set of rules can be used to detect inefficiencies. Once inefficiency is detected, an instant notification can be sent to the user or periodic reports can be sent to the user, management or any other entity.

### BACKGROUND OF THE INVENTION

1. Technical Field of the Invention

The present invention relates to computer methods for improving the efficiency and effectiveness of instant messaging between users on various computing devices.

2. Description of the Prior Art

Instant Messaging (“IM”) is a well known and increasingly popular and productive tool for remote collaboration. However, it is frequently misused. Many IM conversations would be more productive if carried out over the phone or via e-mail. Interactions which would normally take five minutes on the phone instead take an hour as slow typing and multi-tasking users keep communicating with other users through lengthy and intermittent messages. Those who misuse IM do not intend to be annoying or unproductive. They simply do not know how to optimize their use of the various communication media available.

There are various existing software that monitor and report a user's desktop activity. Keystroke monitoring can reveal the use of obscene language and visits to pornographic web sites. There are other software in the market which can filter messages coming from a given user or system, thereby preventing such attempts at communication from reaching another user. These types of filters are mainly used for blocking messages.

Other existing instant messaging (IM) software provide the user the capability to manually indicate whether he or she is away from the office and to automatically trigger a status if the person has not used the keyboard for a while. However, these status indicators are quite limited. The manual status requires human effort and people frequently forget or do not bother to update the indicated status when the underlying status changes. While the visibility to keyboard typing is helpful, this prior art does not address what the typist is doing. For instance, the typist may be deep in thought in a UNIX session, or casually doing e-mail, or just browsing the internet. The person may be engaged on another device (e.g. cell phone, regular phone, P.D.A., etc.). The person may be engaged in a one-on-one phone call requiring his full attention, or participating in a 10-person conference call containing some idle thought time.

Prior art US Patent Application 20050055412 describes not displaying a message immediately and rather adding it to a visible list of waiting messages in a particular window on the recipient's client device. Prior art US Patent Application 20020163572 describes converting a waiting message to email if the message has been waiting for a given period of time and has not been viewed by the recipient. In the present invention we are illustrating a more effective way of delaying the message from being received by the recipient based on rules which are more sensitive to the recipient's current activity or application that is being used. We consider this more effective and efficient because the intent of IM should be to make a message available to users as soon as possible without disturbing their current activity or distracting them from their current activity.

### SUMMARY OF THE INVENTION

One idea of the present invention is to automatically identify the user status based on the most recently used foreground application (e.g. Unix or email) or other communication devices (regular phone, cell phone, PDA, etc.), including the number of participants in any community activity (e.g. conference call, #people engaged in an IM session). Once the details of user status have been determined, the invention will transform this into a meaningful status summary along with a color indicator such as green indicating the (potential) IM recipient is available for an IM interruption, red indicating that the (potential) recipient is unlikely to be available and yellow indicating the (potential) recipient is possibly available. The potential IM initiator/sender may scan his cursor across the color to obtain more details on the (potential) recipients activity. This summary status information gives the initiator a clue as to whether or not he would be more successful (and/or considered more cooperative) communicating via e-mail, a scheduled phone call, or other means.

An annoying aspect of current IM software is that when you are in the middle of typing a sentence another IM message pops up on your screen. It would be preferable that such interruptions do not occur in mid-sentence. Consequently, one aspect of the present invention provides the capability to delay the receipt of a message until after the recipient has stopped typing for a few seconds. Further this invention describes a method of specifying the delay in the receipt of the message by the recipient based on the type of activity the recipient is doing currently in addition to the length of time the recipient has stopped doing the current activity. If a receiver is using e-mail, then it is fine to interrupt the user after, for example, a two second delay, but if the receiver is writing in a word-processor (which typically requires more thought and care), then, for example, a four second delay would be appropriate, and if the recipient is involved in editing computer source code in a UNIX session, perhaps a ten second delay would be more convenient. All of these parameters and many other similar parameters would have default values populated by the provider of the invention's software but with overrides configurable by the using organization's systems administrator and ultimately could be overridden by an astute individual user.

Generally speaking, IM tools tend to work well for brief communications and poorly for long ones. The impact depends upon the subject context, personal preference, and on what the parties would otherwise be doing (e.g. trying to maintain a different train of thought).

A further idea of the invention is to monitor and examine IM activity for likely inefficient usage (based on configurable rules), and any misuse is reported either directly to the user or to someone in their management chain or to another networked party or entity. Notification is provided via pop-up messages on the screen or through periodic reports. Misuses could be of various types, for example, multiple sentences in a single long message, beginning an IM session even though the user is pre-occupied with other activities resulting in a very long time consuming session for involved parties or too many short messages within a given interval and so on

Ineffective and inefficient usages can be identified by monitoring the IM activity and identifying them based on configurable rules. The following are typical types of measurements that would provide some of the raw material for identifying probable misuse: status of the receiving user, current activity of the receiving user, number of messages in a given interval, length of the messages, number of seconds to begin a reply, duration between messages, time taken to type a message etc.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a sample IM system architecture

FIG. 2 is an example of networked devices

FIG. 3 is a table of sample status rules

FIG. 4 is a flowchart illustrating steps to derive a meaningful summary status

FIG. 5 is a sample table illustrating sample rules for delay of receipt of a message

FIG. 6 is a flowchart illustrating steps for delaying the receipt of a message

FIG. 7 is an illustration of time elements involved in an IM session interaction

FIG. 8 is a sample flowchart illustrating inefficient usage and alert notification

FIG. 9 is a flowchart illustrating generation of periodic reports

FIG. 10 is a table summarizing IM inefficiencies and corresponding actions suggested by the invention

### BEST MODE

The primary intent of this invention is to make IM an efficient and productive tool for communications between two or more users. IM can be an effective tool if used appropriately, but the user or users on either end of the communication can unintentionally use the tool in a manner which is inefficient and ineffective for all the users involved in the communication. This invention addresses some of the problems in IM usage that decrease user productivity.

All IM tools involve a client interface that the user will use to send the messages. These messages may go directly from the sender to the receiver or may pass through an intermediate server(s) before reaching the receiver. It is possible in this situation for the client interfaces or the server(s) to make various measurements like the status of the user activity, speed of typing by the user or the interval between each message or the length of the input message by means other than typing like cut and paste or importing files etc. Further, most modern communication devices like the computer, phone, PDA, etc. can be connected to a network server and their usage status can also be monitored. We use the expression Instant Messaging (“IM”) quite broadly to include information communicated in a variety of forms (text, voice, other sounds, vibrations, smell, etc.) and mediums (e.g. desktop computers, laptops, personal digital assistants, remote control devices, motorized vehicle, airplane, satellite, pager, telephone, cell phone, air, etc.) which will be recognizable to those skilled in the art.

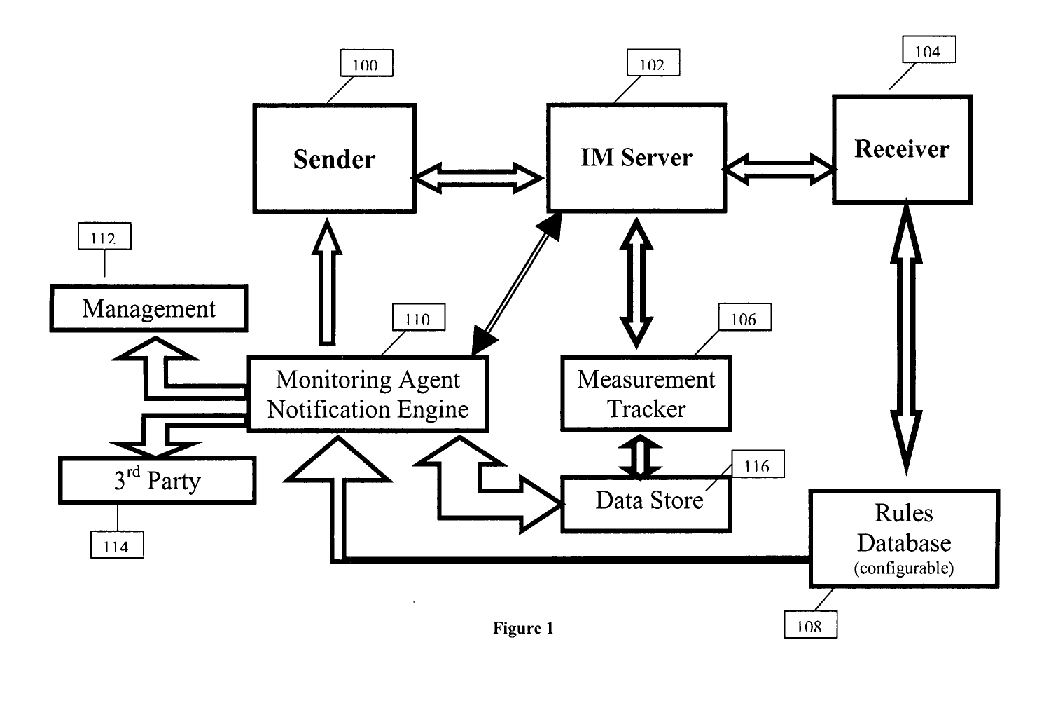

A sample IM system that can implement the present invention is illustrated in FIG. 1. Block 100 represents the sending user who is initiating the communication with the receiving user in block 104. The message travels through an IM server shown in block 102 before reaching the receiving user. A measurement tracker shown in block 106 is part of the IM server that records the various measurements and stores it in a data store shown in block 116. Further the receiving user (block 104) has access to a set of individual rules installed as part of the IM software that are stored in a rules database (block 108). The users may decide to use the default settings of these rules or they can customize the rules according to their preferences. The monitoring agent shown in block 110 monitors the measurements and verifies if the measurements violate or exceed the settings as specified by the rules for a particular receiving user. If there is a violation of a rule, the monitoring agent of 110 then notifies the notification engine of 110. The notification engine then issues the appropriate notification based on the notification settings. For instance, a notification may be sent to any or all of the sender (110), his management or administrative management (112), or a third party (114).

The client interface at each user's IM input device will be capable of modifying the user's unique set of rules. The server administrator will be capable of setting the generic rules that will be applied as defaults for all the users during the initial installation of the IM client software.

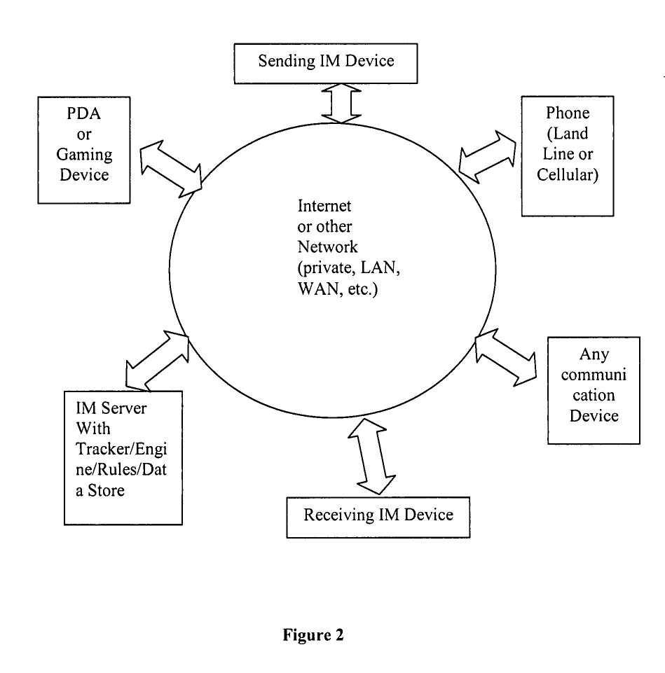

Many modern digital devices can be networked together into an IM system as illustrated in the example of FIG. 2. Shown are various devices connected via a network. Included, as examples, are land line and cellular phones, PDAs and gaming devices, IM Servers, and sending and receiving devices which can be any combination of devices mentioned herein.

In one embodiment of the invention, the system will identify the status of the user activity and based on certain rules provide a meaningful summary of the activity before, during, and after a given IM session. The status of a user's activity can be of many types. One such type of activity would be the user is currently using a device that may be different from the IM device. If this device is connected to the network, the IM system can detect the activity and take measurements as needed. Devices can include regular telephones or PDA or cellular phones or similar digital devices. Also if the user is on a conference call or in a multi-user IM session then measurements about the number of parties involved and duration of the session can be measured.

All the communication devices mentioned herein can be connected to a network, for example, based on Ethernet, FDDI (Fiber Optics), Wireless, SONET, or any other similar industry standard protocol type of network so that the measurement tracker can retrieve the information from the server that controls these devices. For example, information about cell phone usage or landline phone usage is maintained by the phone provider's server. Similarly, many IM devices are connected to an IM server using TCP/IP over Ethernet, for example. The tracker can receive the required information from the provider's server and then store it in the Data Store. Details of how the provider's server maintains such information are described in well known industry standard implementations such as Session Initiation Protocol (SIP), and are not described further herein. These details will be well known in the art to those familiar with the service provider industry standards and can be obtained, for example, from the Internet Engineering Task Force website as RFC 3261 at http://www.ietf.org/rfc/rfc3261.txt.

Another type of activity would be where the user is involved in using another application like a word processor or email or UNIX X window based application or a telnet application, etc. The duration for how long such an application has been used or the interval since the user has stopped using such an application can also be measured. Many IM client software are capable of making such measurements and then sending them to the IM server. IM client software such as Lotus Sametime, Yahoo Messenger, and similar such clients are capable of detecting the user input on a given IM device.

Based on the above mentioned user activities and the measurements taken about these activities, rules can be designed to automatically identify the status of the user and provide a meaningful summary. The summary status can also be shown as color coded statements to make for easier identification of user's availability. For example, green may indicate that user is most likely available for starting an IM session, yellow indicating the user is probably free enough to be distracted or red indicating the user is currently busy and should not be disturbed for non-emergencies. The present invention is unique in arriving at the colors based on a meaningful summary of the recipients' current activities and this status summary message along with the color form an implementation of one of the embodiments of this invention.

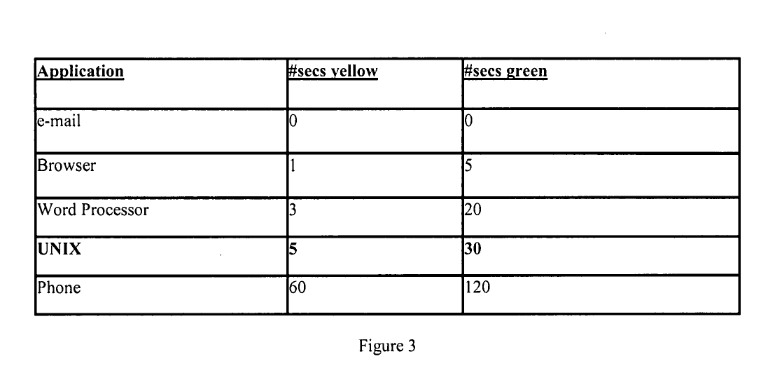

A table of sample status rules illustrating the above embodiment is shown in FIG. 3. Suppose that a potential IM recipient has most recently been using the UNIX application. Based on the fifth row of the table in FIG. 3, if the recipient has been typing within the past five seconds, then it is highly likely that the recipient is actively engaged in serious thought and would prefer not to be disturbed. The recipient's summary status would be red. If the potential recipient has not typed anything into the UNIX session within the past 30 seconds, then the recipient is most likely available and the status would be summarized as green whereas activity between five and 30 seconds ago would indicate a yellow status. However, if the recipient had most recently been using an email function, then the recipient probably does not mind being interrupted: green regardless of time of last typing as indicated by the second row in the table of FIG. 3. Word Processor use may have parameter settings between those of email and UNIX since using a word processor would typically require shallower thought than editing UNIX code but deeper thought than email. Of course, the above mentioned sample rules are for illustration purposes only. Many such similar rules can be specified by individual users or groups to further derive a more meaningful summary status message.

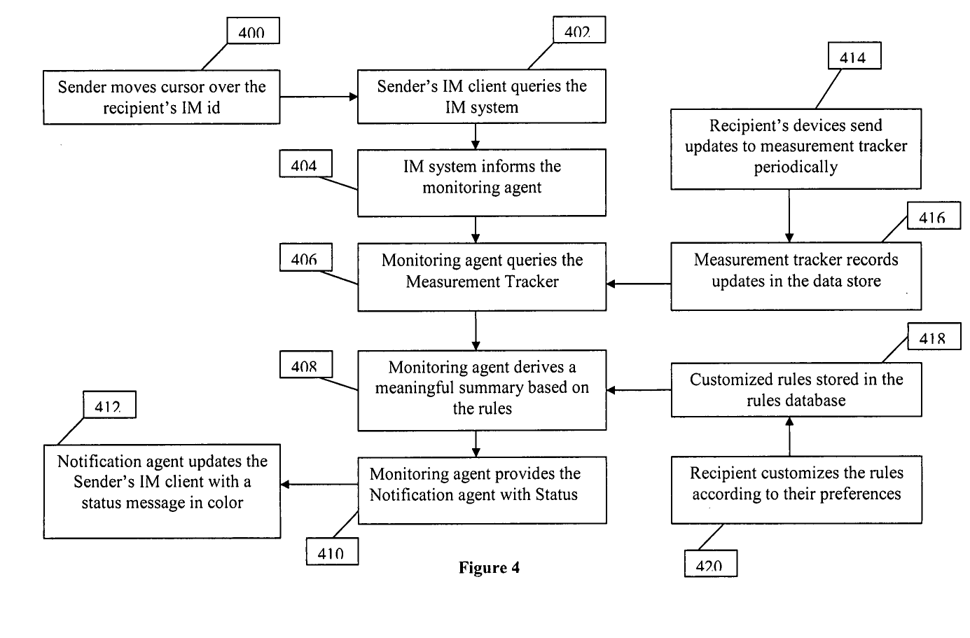

In FIG. 4 we illustrate a flowchart that describes how a sample IM system can derive a meaningful summary status and display it on the sending user's IM client device. Even though we illustrate how the status is derived when a sender is about to initiate an IM session, the same flow can be implemented during an ongoing IM session as well as after an IM session has ended so that a constant status about a recipient is always available to the sender

When the sender is about to send a message to the recipient, the sender would move the cursor over the recipient's IM identifier first as mentioned in block 400 of FIG. 4. At that time, the sender's IM client will send a query to the IM system (block 402) soliciting the status of the recipient. The IM system informs the monitoring agent to find the status (block 404). The monitoring agent then queries the measurement tracker for relevant measurements of that particular recipient that were stored recently (block 406). Once the monitor has the measurements it then queries the rules database to get the rules defined by the recipient and the monitoring agent applies the rules to the measurements and arrives at a meaningful summary status (block 408). The monitoring agent then provides this information to the notification engine (block 410). The notification agent then updates the sender's IM client with the status message (block 412) using appropriate color or other designation which identifies the summary status. Based on the status message displayed the sender may now decide whether to initiate a session with the recipient or not, thereby improving the efficiency for both the sender and recipient.

FIG. 4 also illustrates how the measurements are periodically tracked by the measurement tracker (block 414) and then sent to a data store (block 416) which will be retrieved later by the monitoring agent. Further the recipient has the ability to customize the rules (block 420) which are stored in the rules database (block 418) which will be retrieved by the monitoring agent later for arriving at a meaningful summary status.

Another embodiment of the present invention describes how the receipt of the message sent by the sender is displayed in a delayed manner to the recipient. Often users are interrupted by popup windows or blinking windows indicating the arrival of a new IM message. Many times, this disturbs the thought process of a recipient who may be involved in deep thought over another activity or using another application. In this embodiment we describe rules that may control if and when an incoming message may be displayed to the recipient. Until then the message is held in a queue by the IM system without being sent to the recipient's IM client.

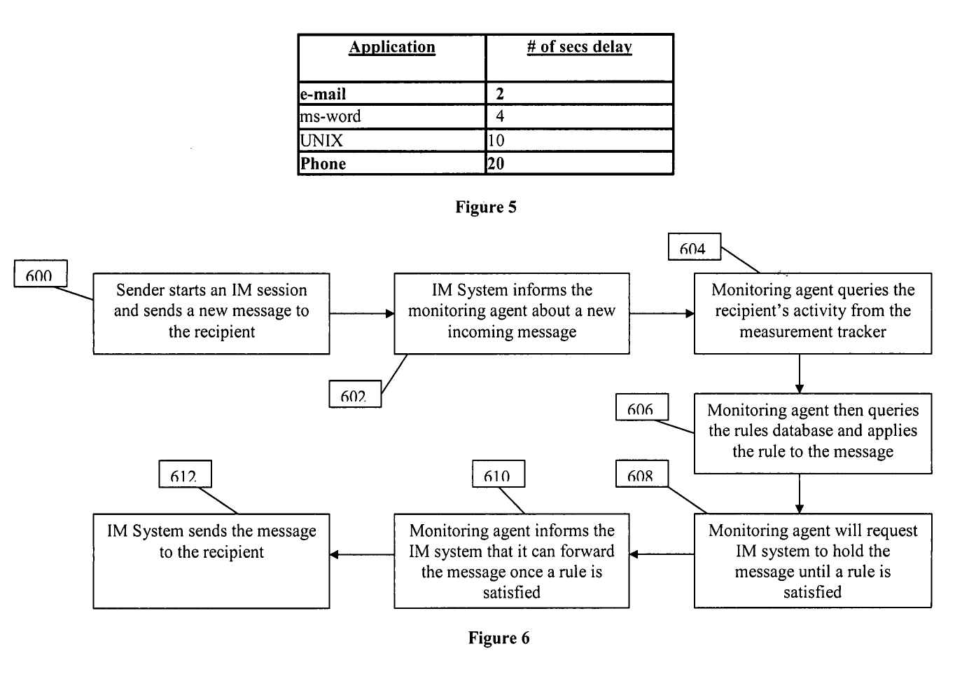

A sample set of rules that can implement the above mentioned embodiment is shown in FIG. 5 which indicates the minimum number of seconds a recipient would need to stop typing or stop using a certain application before the next incoming IM message is received. While the rules illustrated in FIG. 3 may indicate when senders are welcome to send IM messages based on the various activities of the recipient, FIG. 5 indicates that the recipient will not receive that message until after he has stopped typing or using a certain application for a specified amount of time. Note that the parameters of FIG. 3 and FIG. 5 refer to different concepts and thus may be applied independently of each other to the extent the situation warrants. As an example, from the last line item of FIG. 5, if a person has spoken on the phone within the past twenty seconds, most likely he is actively engaged in the conversation and would prefer not to have an IM message pop up on his screen. The phone provider's server is capable of detecting 1-way or 2-way conversations and the length of such conversations (based on current industry wide implementations) and the measurement tracker can retrieve such information from the provider's server. Also, the timer is actually the monitoring agent which queries the measurement tracker continuously and applies the rules for a given user. A data store can be programmed to trigger when certain conditions are met and update the information for a user in the data store. Software such as IBM DB2 and Oracle Database and similar commercial software have well known functions sometimes referred to as Stored Procedures and Triggers which can be used for this purpose. The monitoring agent will be able to apply this derived information to the preconfigured rules and arrive at a result or summary status.

FIG. 6 illustrates how the above embodiment can be implemented in an example IM system. The sender initiates an IM session with the recipient and sends a new message to the recipient as shown in block 600. The IM system informs the monitoring agent about the new message to the recipient (block 602). The monitoring agent then queries the measurement tracker (block 604) to get information about the recipient's current activity such as what recent application or device the recipient has been using and for how long has the recipient stopped using the application or device etc. The monitoring agent then queries the rules database (block 606) to find the rule that implements the delay for a given application or activity. If the rule is not satisfied, the monitoring agent will request the IM system to hold the message in a queue (block 608). The monitoring agent will keep retrying to apply the rule for that message until the rule is satisfied. Once the rule is satisfied, the monitoring agent will inform the IM system to forward the message (block 610). The IM system will then forward the message to the recipient (612) and clear it from the queue for that recipient.

Another important aspect of the present invention is monitoring the IM activity for inefficiency. In this embodiment we describe how the IM system would monitor the user's activity by recording various measurements about his IM usage and then, based on certain rules or formulae, identify if the user is misusing or using IM in an inefficient manner. The method notifies the user about the misuse and may suggest an efficient alternative to the current communication. Also periodic reports about such misuse may be generated and forwarded to the user or management or another party as optionally configured in the IM system.

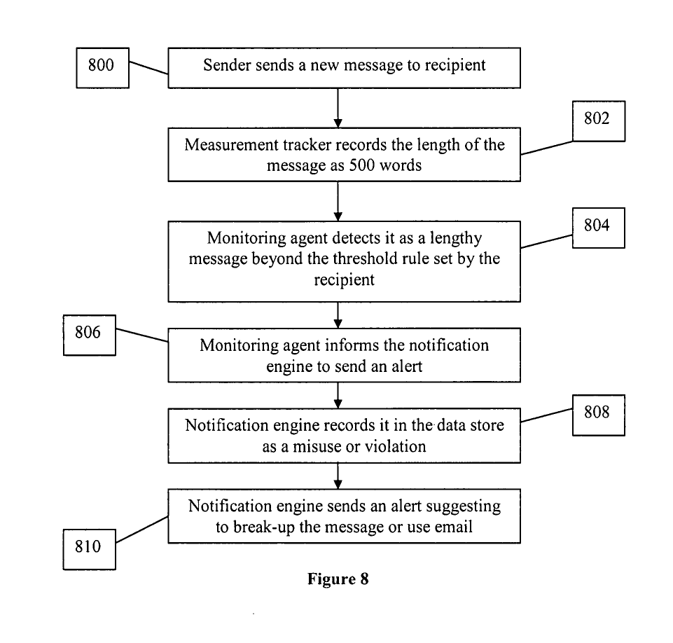

The work flow illustrated in FIG. 8 describes a sample implementation of the above embodiment. Sender starts a session with a recipient and sends a message (block 800). The measurement tracker calculates the number of words in the message and records it to the data store (block 802). Before delivering the message to the recipient the IM system informs the monitoring agent to verify if the message violates any of the rules for inefficiency & misuse. In this example the rule is that any message above 250 words is considered to be a very long message. As a result the monitoring agent detects this as a misuse (block 804). Since it has been detected as a violation, the monitoring agent informs the notification engine to send an alert to the user (806). The notification engine records this violation in the data store (808) and then sends an alert to the sender's IM client device (810). The alert will be displayed as a popup message or blinking window on the sender's device.

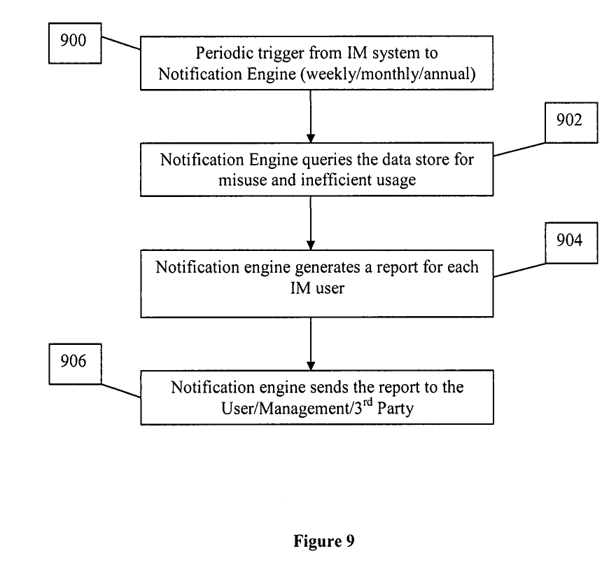

Repeated violations by a user can be highlighted in a periodic report. FIG. 9 describes a work flow for generating such reports. The administrator of an IM system can schedule periodic jobs (block 900) that will trigger the notification engine to generate reports. The notification engine then queries the data store for all the violations or misuses within a given period (block 902). The notification then groups and generates a report for each IM user within the system (block 904). It then uses the settings as configured in the IM system to forward this report to the user and, if so configured, to the management or 3^{rd} party (block 906).

Rules can be built based on the various measurements recorded and can be as simple as a binary combination of the measurements or some advanced formulae. Again these rules will have default values during the initial install of the IM client, as set by the IM system administrator, but they can be configured to the preferences of a recipient user.

The various types of measurements recorded by the measurement tracker may include but are not limited to the following list of items shown below:

1. Speed of typing a message by the sending user (words per minute).

2. Length of a single input message from a sending user (e.g. number of words in a message) not counting any imported text from another source like a file or cut/paste operation.

3. Interval between each message in a conversation from a single sending user (number of seconds between a reply from a receiver and the next message from a sender).

4. Number of messages from a single sending user during a given period of time (e.g. number of messages per hour).

5. Number of messages from multiple sending users during a given period of time (e.g. number of messages per hour and the number of senders).

6. Status of the receiving user—the receiving user's client interface indicates that the user has started typing his response or he is talking on another device.

7. Status of the receiving user—does the user's client interface indicate the user is away and the duration that the user has his IM status as marked away (a status message from the client interface of the receiver to the tracker).

8. Status of the receiving user—is the user using another device like a Telephone, Cellular Phone, PDA etc. (a status message from that device to the tracker).

9. Status of the receiving user—is the user working on an application like word processor, spreadsheet, presentation, Unix, email, browser etc and the duration that the user is using such an application (the name of the foreground application, other than the IM client interface and the duration that this application has been in the foreground).

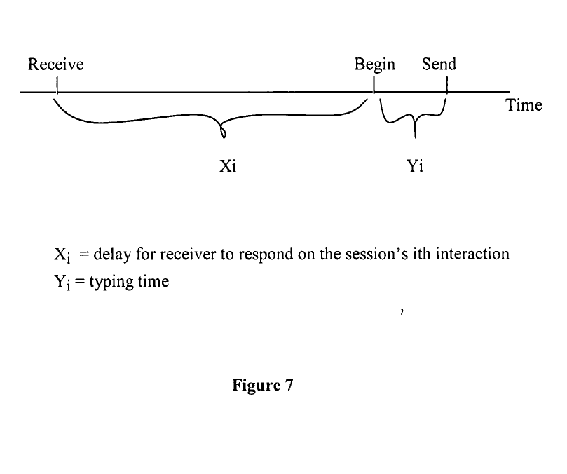

FIG. 7 shows a time line illustrating the receipt of an IM message i as the leftmost vertical bar. A period of time (Xᵢ) later, the recipient begins typing a response. After another period of time (Yᵢ) later the message has been completed and sent. A simple rule may be: if a recipient has delayed the beginning of a response for more than two minutes on three occasions during this session j, then a pop-up message would appear on the sender's screen indicating that the recipient is distracted and thus the sender should consider sending e-mail, voice-mail, or wait until another time such as may be later indicated by a green status.

An example of a more advanced rule is shown below:

$${S}_{j} = \frac{{\sum }_{i = 1}^{n} ( {c}_{1} \sqrt{{x}_{i}} + {c}_{2} \sqrt{{y}_{i}} )}{{\int }_{t}^{} f ( {status}_{t} ) ⅆ t}$$

n=number of messages in a session (thus far)
Xᵢ=delay on the session's ith interaction
Yᵢ=typing time
c1, c2=constants (optionally configurable)
status=red, yellow, or green
Sⱼ=Summary measure for session j reflecting efficiency

The rule would be to display an alert to the sender if

$$\frac{{S}_{j}}{\sqrt{n}}$$

is too high. Also another rule would be to send a periodic report if S̅ too high.

The general idea is that the variable Sⱼ measures the extent to which IM session j is efficient. If there are many delays in beginning to respond (high values of X) or the messages take too long to type (high values of Y), then the value of Sⱼ will tend to be large. If Sⱼ is too large, then a pop-up alert is displayed on the offender's screen while consistently high average values of S will trigger a notification in a periodic report such as would be sent to the offender and potentially his manager or a third party official (e.g. IM policeman). The example above takes square roots of the Xs and Ys so as to dampen the impact of occasional long durations which do not indicate a consistent pattern. Notice that constant factors C₁ and C₂ are optionally configurable and indicate the respective impact due to distraction and slow typing. The formula for Sⱼ shown above divides by a time weighted factor which reflects the status of the IM participant based on his preoccupation with other tasks. f(red) would be a relatively low number, f(green) high, and f(yellow) moderate so as to encourage especially efficient IM interactions when a participant is focused on those tasks which are especially desirous to be left uninterrupted. Of course, this is just an example of one embodiment of this type of rule.

In the denominator of the formula, the integral summation interval t, includes the point in time at which the IM session begins until the present time. f(status) refers to a function based on the status (red, yellow or green). For instance, a reasonable function f may return 1 for red, 5 for yellow and 20 for green. That is, f(red)=1, f(yellow)=5, and f(green)=20 which would make the value of Sⱼ larger when the receiver of the IM is busy with something indicating a “red” status (e.g. actively speaking on the phone).

It should be understood by those of ordinary skill in the art, however, that the present invention is not limited to the above implementation and is independent of the types of IM devices or IM architectures. Accordingly the present invention can be implemented on any IM device or computing platform or operating system or programming language that is capable of sending and receiving IM messages.

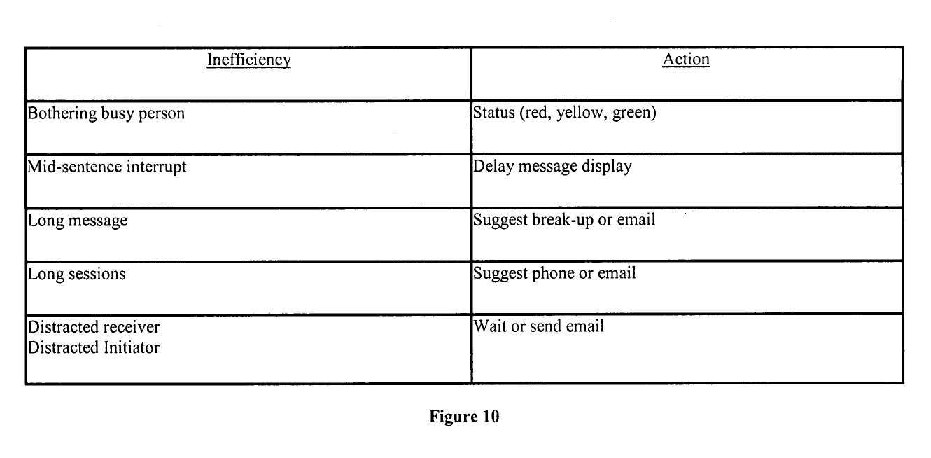

FIG. 10 is a summarized example of inefficiencies that can be identified by implementing the present invention, and corresponding actions to take as a result of the inefficiency. For example, if the invention identifies that the message sent by the sender is longer than the threshold set by the receiver it can display a message to the sender suggesting to break up the message into smaller messages or send it via an email.

It should be understood by those of ordinary skill in the art that the present invention is not limited to the above implementation and is independent of the types of IM devices or IM architectures. Accordingly the present invention can be implemented on any IM device or computing platform or operating system or programming language that is capable of sending and receiving IM messages.

We claim:

1. A method for improving the efficiency and effectiveness of communication between a plurality of users communicating over a network using communication devices, comprising the steps of:
monitoring one of said user's activity on at least one communication device;
automatically evaluating said one of said user's status;
converting said one of said user's status into a summary status based on preconfigured stored rules; and
transmitting said summary status to at least another one of said plurality of users.

2. A method according to claim 1 wherein the step of transmitting includes activating a status indicator at said at least another one of said plurality of users' communication device.

3. A method according to claim 1, further comprising the steps of:
transmitting a message directed by said at least another one of said plurality of users to said one of said user's communication device; and
delaying receipt of the message at said one of said user's communication device for a time interval that is based on said one of said user's status.

4. A method according to claim 3 wherein the step of converting comprises the step of:
accessing a table of stored rules.

5. A method according to claim 3 wherein the step of converting comprises the step of:
calculating an efficiency value based on a preconfigured formula that incorporates results obtained from the step of automatically evaluating.

6. A method according to claim 1, wherein the step of monitoring one of said user's activity comprises:
measuring the time it takes for said one of said users to begin recording a response after receiving a message from another one of said plurality of users at said one of said user's communication device.

7. A method according to claim 1, wherein the step of monitoring one of said user's activity comprises:
measuring a time taken to compose a message on said one of said user's communication device.

8. A method according to claim 1, wherein the step of monitoring one of said user's activity comprises:
identifying said at least one communication device that said one of said users is using at a given time.

9. A method according to claim 1, wherein the step of monitoring one of said user's activity comprises:
identifying a number of other simultaneous users of said at least one communication device that said one of said users is using at a given time.

10. A method according to claim 1, wherein the step of monitoring one of said user's activity comprises:
identifying whether an application activated on said at least one communication device being used by said one of said users is in the foreground.

11. A method according to claim 1, wherein the step of monitoring one of said user's activity comprises:
identifying if said one of said users is transmitting messages on said at least one communication device during a time period when he is receiving messages.

12. A method according to claim 1, wherein the step of monitoring one of said user's activity comprises:
identifying if said one of said users is communicating on more than said at least one communication device at a given time.

13. A method for improving efficiency of communication between a plurality of users using a plurality of communication devices over a network, comprising the steps of:
monitoring communication device activity of one of said plurality of users;
identifying instances of activity by said one of said plurality of users that exceed preconfigured thresholds; and
transmitting information indicative of corrective activity to said one of said plurality of users such that, when exercised, the corrective activity tends to increase efficiency of the communication device activity of said one of said plurality of users.

14. Method according to claim 13, wherein the step of transmitting includes activating a pop-up alert at a communication device display used by said one of said plurality of users.

15. Method according to claim 13, wherein the step of identifying comprises the steps of:
generating a report that records said instances of activity by said one of said plurality of users that exceed preconfigured thresholds; and
transmitting the report to a preconfigured entity on the network.

16. Method according to claim 13, wherein the step of identifying comprises the steps of:
measuring whether said one of said plurality of users is sending multi-sentence messages during a preconfigured period of time.

17. Method according to claim 13, wherein the step of identifying comprises the steps of:
measuring whether said one of said plurality of users is initiating communication sessions that exceed a preconfigured threshold.

18. Method according to claim 13, wherein the step of identifying comprises the steps of:
detecting whether said one of said plurality of users is transmitting an amount of short messages to only one other user that exceeds a preconfigured threshold.

19. A program storage device readable by machine, tangibly embodying a program of instructions executable by the machine to perform the method steps of claim 1.
